(19) United States
(12) Patent Application Publication
(10) Pub. No.: US 2006/0287179 A1
(43) Pub. Date: Dec. 21, 2006

(54) Roll, a roll ring and a method in the production of such a roll

(75) Inventors: Jorge Gleizer, Bandhagen (SE); Milinko Prusic, Saltsjo-Boo (SE); Jan-Erik Karlsson, Tyreso (SE)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB

(21) Appl. No.: 11/447,313

(22) Filed: Jun. 6, 2006

(30) Foreign Application Priority Data
Jun. 17, 2005 (SE) 0501384-2

(51) Int. Cl. F16C 13/00; B21D 53/00

(52) U.S. Cl. 492/47; 492/40; 492/45; 29/895.21

(57) ABSTRACT

A combi roll includes a shaft having two spaced-apart stop rings a plurality of roll rings placed between the stop rings, which roll rings individually are composed of an outer ring of a hard metal, and a concentric inner ring of a more ductile metal, which is permanently bonded to the outer ring metallurgically, and has a flange that projects a distance axially from an end of the outer ring. The individual roll ring is rigidly connected to the shaft by way of one or more locking pins, which are inserted in through holes in the projecting flange of the inner ring and engage holes in the shaft.

### FIELD OF THE INVENTION

The present invention relates to a roll of the type that comprises, on one hand, a drive shaft or roll shaft having two axially spaced-apart stop rings, one of which is fixed and the other one is a lock nut, and on the other hand, a number of roll rings placed between the fixed stop ring and the lock nut, which roll rings individually are composed of an outer ring of a hard metal, and a concentric inner ring of a more ductile metal, which is permanently bonded to the outer ring metallurgically, and has a part that projects a distance axially from an end of the outer ring.

### BACKGROUND

Rolls of the type generally mentioned above—which by those skilled in the art are referred to as combi rolls—are in practice used for hot or cold rolling of long narrow products of metal, such as wires, bars, pipes, etc. For this purpose, the roll rings—which in this case are denominated composite roll rings—are formed with a number of circumferential grooves, which form the product in the desired sequence. The number of grooves may vary from only one to a plurality. The capacity of the roll is determined by how many roll rings that can be mounted within the given roll width, such as this is determined by the distance between the fixed stop ring and the lock nut.

An important factor for a lasting good function of such rolls is that the roll rings are rotationally secured in a reliable way, since extremely large torques have to be transferred from the drive shaft to the roll rings without slipping of the rings in relation to each other and in relation to the shaft. In the technique in question, many different proposals have been made (see, for instance, U.S. Pat. No. 4,280,147, U.S. Pat. No. 5,248,289, U.S. Pat. No. 5,558,610, U.S. Pat. No. 5,735,788 and U.S. Pat. No. 6,685,611) for solutions of the problem of rotationally securing such roll rings that are manufactured from comparatively brittle cemented carbide, and which therefore have good properties as to compressive strength and resistance to wear, but an inferior tensile strength. However, common to previously known rolls is that the elements (e.g. wedges, springs, hydraulic devices) having the purpose of securing the roll rings rotationally all occupy a certain part the roll width, i.e., the available axial space between the fixed stop ring and the lock nut of the shaft.

### SUMMARY

The present invention aims at obviating the above-mentioned shortcomings of previously known rolls and at providing a roll having an improved capacity. Therefore, a primary object of the invention is to provide a roll, the composite roll rings of which can be rotationally secured in relation to the roll shaft by way of elements that do not occupy any significant part of the available roll width. Another object is to provide a roll that is easy to manufacture, at the same time as the roll should be possible to redress in a practical way. Yet an object of the invention is to provide a roll, the roll rings of which are rigidly secured in relation to the drive shaft in a way that is at least as strong and reliable as in previously known rolls.

According to a first aspect of the present invention, a roll comprises a drivable shaft having two axially spaced-apart stop rings, one of the stop rings being fixed and the other of the stop rings is a lock nut. A plurality of roll rings are disposed between the fixed stop ring and the lock nut. The roll rings individually are composed of an outer ring of a hard metal, and a concentric, inner ring of a more ductile metal, which is permanently bonded to the outer ring metallurgically, and has a part that projects a distance axially from an end of the outer ring. The individual roll ring is rigidly connected to the shaft by way of one or more locking pins, which are inserted in through holes in the projecting part of the inner ring, and engage holes in the shaft.

According to a second aspect of the present invention, a roll ring comprises an outer ring of a hard metal, and a concentric inner ring of a more ductile metal, which is permanently bonded to the outer ring metallurgically, at least one part of the inner ring projecting a distance axially from an end of the outer ring, wherein, in the projecting part of the inner ring, one or more holes are formed that extend continuously between the outside and inside of the part.

According to a third aspect of the present invention, a method for the manufacture of the rolls, includes forming the individual roll ring with one or more through holes in the projecting part of the inner ring. The roll ring is applied to the shaft together with one or more other roll rings. The lock nut is tightened in order to press the roll rings against each other. Holes are drilled in the shaft in the extension of the holes in the inner rings of the roll rings. Locking pins are mounted in the holes.

### BRIEF DESCRIPTION OF THE DRAWINGS

FIG. 1 is a partly cut side view of a roll according to the invention,

FIG. 2 is an enlarged longitudinal section through only one individual roll ring included in the roll, and

FIG. 3 is a partly cut end view of the roll ring according to FIG. 2.

### DETAILED DESCRIPTION

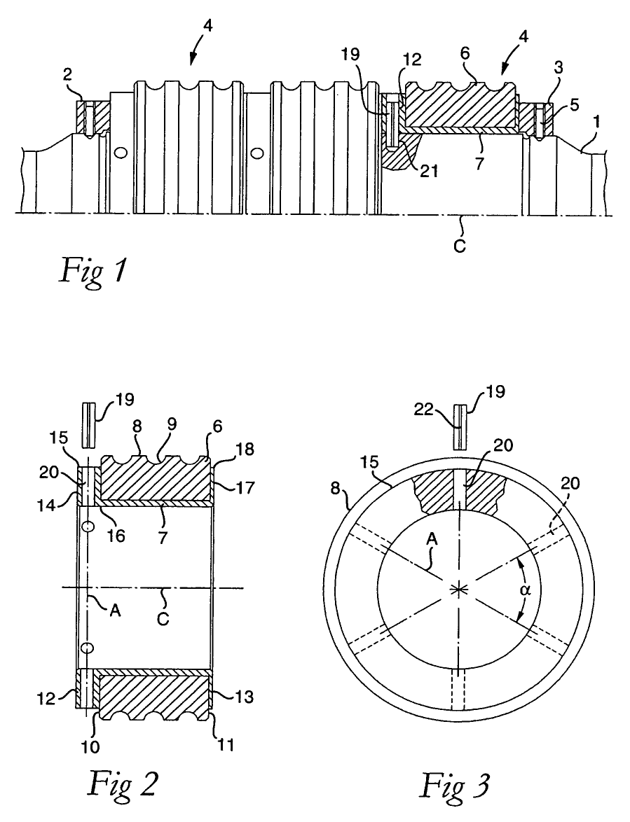

The roll shown partially in FIG. 1 includes a central, drivable shaft or roll shaft 1 having a rotationally symmetrical basic shape. Between two axially spaced-apart stop rings 2, 3, a number of (in this case three) individual roll rings 4 are arranged in the form of composite roll rings. Also the composite roll rings 4 have a rotationally symmetrical basic shape, and are formed with an inner diameter that just slightly exceeds the outer diameter of the cylindrical envelope surface of the shaft 1 extending between the stop rings 2, 3. Thus, the roll rings 4 can be mounted on the shaft with a fine fit.

The stop ring 2 is fixed to the shaft 1, while the stop ring 3 is a lock nut. In the example, the fixed stop ring 2 is a separate component, which is connected to the shaft in such a way that it cannot move axially. The fixed stop ring 2 may, however, also be a ring-shaped shoulder integrated with the rest of the shaft, which shoulder is formed in connection with the machining of the shaft. The second stop ring 2 is a lock nut, i.e. the ring has an internal thread (not shown) that is in engagement with an external thread on the shaft. Furthermore, the lock nut may be secured by way of a locking screw 5 or the like.

FIGS. 2 and 3 illustrate more in detail the structure of the individual roll ring 4. The roll ring has a basic shape that is symmetrical in respect of a central axis C around which the roll ring is rotatable, and coincides with the rotation axis C of the shaft 1 (see FIG. 1). In the roll ring 4, an outer ring 6 of a hard metal is included, as well as a concentric, inner ring 7 of a more ductile metal, which is permanently bonded to the outer ring metallurgically. In practice, the outer ring may be manufactured of such powder components (e.g. tungsten carbide including cobalt as a binder) that are used for the manufacture of conventional cemented-carbide inserts by pressing and sintering. In the inner ring 7, nodular or cast iron may be used. In the envelope surface 8 of the hard outer ring 6, a number of circumferential grooves 9 are formed in which the hot metal is rolled.

As is clearly seen in FIG. 2, the more ductile inner ring 7 is somewhat wider than the outer ring 6 and projects somewhat from the two opposite end surfaces 10, 11 thereof. In the example, the projecting parts are designated 12, 13 and are in the form of flanges, which differ in thickness. More precisely, the flange 12 is considerably thicker than the flange 13. The thick flange 12 is delimited by, on one hand, a planar, ring-shaped end surface 14, which extends perpendicularly to the rotation axis C, and on the other hand an external cylinder surface 15 and an internal cylinder surface 16, which is a part of the entire inner surface of the inner ring. In an analogous way, the thinner flange 13 is delimited by a planar, ring-shaped end surface 17 and an external cylinder surface 18. Thus, each individual flange 12, 13 has an outer diameter that, on one hand, is larger than the inner diameter of the outer ring 6, and on the other hand is smaller than the outer diameter of the outer ring, the end surfaces 10, 11 of the outer ring being partly embedded in the flanges, and metallurgically bonded to these in the same way as in the cylindrical interface between the inside of the outer ring and the outside of the inner ring.

Preferably, the individual roll ring 4 is rigidly connected to the shaft 1 by way of one or more locking pins 19, which are inserted in through holes 20 in one of the flanges, viz. flange 12, of the inner ring 7 and engage holes or seats 21, which mouth in the envelope surface of the shaft 1 and extend a distance into the shaft body. As is seen in FIG. 3, in this case, the individual roll ring includes six such through holes 20, which are equidistantly spaced-apart along the periphery of the ring. Most preferably—though not necessarily—the holes and the appurtenant locking pins are radially oriented, so far that the center axis A of the holes (see FIG. 2) extends perpendicularly to the rotation axis C. In this connection, the angles α between adjacent holes are equally large. More precisely, the angle α in the embodiment example amounts to 60°.

Although the cross-section shape of the holes and the locking pins is not critical to the realization of the invention, it is in practice preferred to make the same having a rotationally symmetrical, preferably cylindrical shape. A cylindrical bore 22 is formed suitably centrally inside the pin body, the diameter of which bore is considerably smaller than the external diameter of the locking pin. In this bore, a tool can be inserted, e.g., a screw, by way of which the locking pin can be pulled out of the holes 20, 21 when the roll rings shall be dismounted from the shaft.

The fit between the locking pin 19 and the holes 20, 21 should be fine. More precisely, the inner diameter of the holes should be at most 0.03 mm larger than the outer diameter of the locking pin. As is seen in FIG. 1, only a smaller part of the total length of the locking pin 19 is housed in the hole or the seat 21 in the shaft, while the greater part of the same is housed in the hole 20 in the flange 12. In practice, at most ⅓ of the length of the locking pin should be housed in the shaft hole 21.

The manufacture or the assembly of the described roll takes place in the following way.

In one step, the shaft 1 is machined and equipped with a fixed stop ring 2 and a lock nut 3. In another step, the composite roll rings 4 are manufactured, e.g., in the general way disclosed in U.S. Pat. No. 5,248,289, incorporated by reference herein. However, in contrast to the roll rings disclosed in this patent document, the roll ring according to the present invention is formed with the radial holes 20 that extend through the flange 12. Most suitably, this is carried out by drilling, although without the holes being given their final diameter. In other words, the holes are drilled with a certain, remaining machining allowance. In the next step, the roll rings 4 are mounted on the shaft 1, and then the lock nut 3 is tightened, the roll rings 4 being pressed in close contact against each other and against the fixed stop ring 2. When this has been effected, each hole 20 in the flanges 12 is drilled at the same time as a hole or seat 21 in the proper shaft is drilled. In other words, one and the same drill (having substantially the same diameter as the locking pin) is inserted so deep that it penetrates into the shaft. In conclusion, the locking pins 19 are applied in the appurtenant holes and are secured in the same in a suitable way in order not to be thrown out when the roll rotates. The retention of the locking pins may be provided by, for instance, a glue layer in the contact surfaces between the pins and the holes. In this state, the roll rings are rigidly connected to the shaft without the help of any axially projecting coupling elements (such as lock keys) in the interface between adjacent roll rings. Thus, the planar end surfaces of the roll rings abut closely against each other, the rotational securing being guaranteed by elements, viz. the locking pins, which are housed in the space between the two end surfaces of the roll ring.

A substantial advantage of the roll according to the invention is that the number of roll rings and grooves associated therewith can be optimized for any given roll width. In the type of roll shown in FIG. 1, it was previously possible to mount only two roll rings each having three grooves, i.e., the roll included six grooves. In accordance with the inventive locking of the roll rings, now three roll rings each having three grooves can be mounted. In other words, the number of active roll grooves has increased by 50%.

The invention is not limited to the embodiment described above and shown in the drawings. Thus, the projecting part of the inner ring of the roll ring may have the same outer diameter as the rest of inner ring, i.e., the projecting part does not embed the end surface of the outer ring even partially. In addition, the inner ring may be formed without any projecting part at the opposite end thereof. In other words, one end of the inner ring 7 may terminate in the same plane as the end surface of the outer ring.

The presently disclosed embodiments are considered in all respects to be illustrative and not restrictive. The scope is indicated by the appended claims, rather than the foregoing description, and all changes that come within the meaning and range of equivalents thereof are intended to be embraced.

1. A roll, comprising:
a drivable shaft having two axially spaced-apart stop rings, one of said stop rings being fixed and the other of said stop rings is a lock nut;
a plurality of roll rings disposed between the fixed stop ring and the lock nut, said roll rings individually are composed of an outer ring of a hard metal, and a concentric, inner ring of a more ductile metal, which is permanently bonded to the outer ring metallurgically, and has a part that projects a distance axially from an end of the outer ring, wherein the individual roll ring is rigidly connected to the shaft by way of one or more locking pins, which are inserted in through holes in the projecting part of the inner ring, and engage holes in the shaft.

2. The roll according to claim 1, wherein the shaft and the individual roll ring have a basic shape that is rotationally symmetrical with respect to an axis around which the roll is rotatable, said individual locking pin being radially oriented so far that it has a center axis that is perpendicular to said geometrical shaft.

3. The roll according to claim 1, wherein the individual roll ring is secured to the shaft by way of a plurality of locking pins, which are equidistantly and equiangularly spaced-apart.

4. The roll according to claim 1, wherein the individual locking pin and the in the shaft and in the projecting part of the inner ring of the roll ring have a rotationally symmetrical shape.

5. The roll according to claim 4, wherein the rotationally symmetrical shape is cylindrical, and that the inner diameter of the holes is at most 0.03 mm larger than the outer diameter of the locking pin.

6. The roll according to claim 1, wherein adjacent roll rings along the shaft are pressed in close contact against each other via contact surfaces in the form of planar, ring-shaped end surfaces, which are unbroken so far that they lack projections and/or countersinks.

7. A roll ring, comprising:
an outer ring of a hard metal, and a concentric inner ring of a more ductile metal, which is permanently bonded to the outer ring metallurgically, at least one part of the inner ring projecting a distance axially from an end of the outer ring, wherein, in the projecting part of the inner ring, one or more holes are formed that extend continuously between the outside and inside of the part.

8. The roll ring according to claim 7, wherein, in the projecting part of the inner ring, a plurality of holes are formed, which are equidistantly and equiangularly spaced-apart.

9. The roll ring according to claim 8, wherein the projecting part or flange of the inner ring is delimited by a planar, ring-shaped end surface, which is unbroken so far that it lacks projections and/or countersinks.

10. A method in the production of rolls of the type having a shaft that has two axially separated stop rings, one of which is fixed, and the other one is a lock nut, and a plurality of roll rings disposed between the fixed stop ring and the lock nut, said roll rings individually being composed of an outer ring of a hard metal, and a concentric, inner ring of a more ductile metal, which is permanently bonded to the outer ring metallurgically, and has a part that projects a distance axially from an end of the outer ring, the method comprising the steps of:
forming the individual roll ring with one or more through holes in the projecting part of the inner ring,
applying the roll ring to the shaft together with one or more other roll rings,
tightening the lock nut in order to press the roll rings against each other,
drilling holes in the shaft in the extension of said holes in the inner rings of the roll rings, and
mounting locking pins in the holes.
